(19) United States
(12) Patent Application Publication
(10) Pub. No.: US 2005/0243889 A1
(43) Pub. Date: Nov. 3, 2005

(54) Digital alloy oxidation layers

(75) Inventors: Jin K. Kim, St. Louis Park, MN (US); Jae-Hyun Ryon, Maple Grove, MN (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignees: Honeywell International Inc.; Finisar Corporation

(21) Appl. No.: 10/896,773

(22) Filed: Jul. 22, 2004

Related U.S. Application Data
(60) Provisional application No. 60/567,072, filed on Apr. 30, 2004.

(51) Int. Cl. H01S 3/08

(52) U.S. Cl. 372/99; 372/92

(57) ABSTRACT

A current confinement layer of a VCSEL includes a digital alloy including a stack of alternating layers of materials that oxidize at different rates, the combination of which oxidizes faster than the individual components.

### CROSS-REFERENCE TO RELATED APPLICATIONS

This application claims the benefit of U.S. Provisional Application No. 60/567,072, filed Apr. 30, 2004 and entitled DIGITAL ALLOY OXIDATION LAYERS, which is hereby incorporated by reference.

### BACKGROUND OF THE INVENTION

1. The Field of the Invention

The present invention relates to vertical cavity surface emitting lasers (VCSELs). More particularly, the invention relates to structures for distributed Bragg reflectors (DBRs) used in VCSELs and methods of fabricating the same.

2. The Relevant Technology

VCSELs represent a relatively new class of semiconductor laser. While there are many variations of VCSELs, one common characteristic is that they emit light perpendicular to a substrate's surface. Advantageously, VCSELs can be formed from a wide range of material systems to produce coherent light at different wavelengths, e.g., 1550 nm, 1310 nm, 850 nm, 670 nm, etc.

VCSELs typically include semiconductor active regions, distributed Bragg reflector (DBR) mirrors, current confinement layers, substrates, and contacts. Because of their complicated structure, and because of their material requirements, VCSELs are usually grown using metal-organic chemical vapor deposition (MOCVD) or molecular beam epitaxy (MBE).

FIG. 1 illustrates a typical VCSEL 10. As shown, an n-doped gallium arsenide (GaAs) substrate 12 has an n-type electrical contact 14. An n-doped lower mirror stack (including a DBR) 16 is formed on the GaAs substrate, and an n-type graded-index lower spacer 18 is disposed over the lower mirror stack 16. An active region 20, usually having a number of quantum wells, is formed over the lower spacer 18. A p-type graded index top spacer 22 is disposed over the active 20, and a p-type top mirror stack (including another DBR) 24 is disposed over the top spacer 22. Over the top mirror stack 24 is a p-type conduction layer 9, a p-type cap layer 8, and a p-type electrical contact 26.

Still referring to FIG. 1, the lower spacer 18 and the top spacer 22 separate the lower mirror stack 16 from the top mirror stack 24 such that an optical cavity is formed. As the optical cavity is resonant at specific wavelengths, the distance between the mirror stacks are controlled to be resonant at a predetermined wavelength (or at multiples thereof). At least part of the top mirror stack 24 includes a current confinement layer 40, which is an electrically insulative region that provides current confinement. The current confinement layer 40 can be formed by forming an oxide layer beneath the top mirror stack 24 to define a conductive annular opening 42 which confines electrical current flow to the active region 20 and eliminates transverse mode lasing. Generally, the current confinement layer 40 is formed by exposing a high aluminum content Group III-V semiconductor material (e.g., AlₓGa₍₁₋ₓ₎As) to a water containing environment and a temperature of at least 375 DC, thereby converting at least a portion of the aluminum bearing semiconductor material to a native oxide.

In operation, an electrical bias causes an electrical current 21 to flow from the p-type electrical contact 26 toward the n-type electrical contact 14. The current confinement layer 40 and the conductive opening 42 confine the current 21 such that the current flows through the conductive opening 42 and into the active region 20. Some of the electrons in the current 21 are converted into photons in the active region 20. Those photons bounce back and forth (resonate) between the lower and top mirror stacks 16 and 24. While the lower and top mirror stacks 16 and 24 are very good reflectors, some photons leak out as light 23 that travels along an optical path through the p-type conduction layer 9, through the p-type cap layer 8, through an aperture 30 in the p-type electrical contact 26, and out of the surface of the VCSEL 10.

It should be understood that the VCSEL 10 illustrated in FIG. 1 is a typical device, and that numerous variations are possible. For example, dopings can be changed (e.g., by providing a p-type substrate), different material systems can be used, operational details can be tuned for maximum performance, and additional structures, such as tunnel junctions, can be added.

While generally successful, VCSELs such as those illustrated in FIG. 1 are not without their problems. For example, a major problem in realizing commercial quality VCSELs capable of lasing at long wavelengths of 1310 nm, 1550 nm, etc., relates to the materials used in forming the current confinement layer 40. For example, current confinement layer 40, including high aluminum content Group III-V semiconductor materials (e.g., AlₓGa₍₁₋ₓ₎As, etc.), are lattice matched to GaAs material systems. Lattices are often matched to avoid introducing strain into the VCSEL structure that might reduce the reliability of the device. GaAs material systems are often used in VCSELs capable of emitting at wavelengths of 850 nm and below and are thus of little commercial value in the telecommunications industry which operates at long wavelengths of 1310 nm, 1550 nm, etc. Therefore, long-wavelength VCSELs are often based on InP material systems. However, there is no “x” value for which AlₓGa₍₁₋ₓ₎As is suitably lattice matched to InP. Aluminum containing semiconductor material such as Al_{y}In_{(1-y)}As is lattice matched to InP where “y” is about 0.5. However, at such low aluminum content, the InAIAs material oxidizes too slowly (i.e., ˜1 μm/hour @ 500° C.) to be economically used in forming the current confinement layer 40.

It is generally understood that the current confinement layer 40 is oxidized via a substitutional process whereby oxygen is substituted for a Group V element within the semiconductor material (e.g., As is substituted for O, wherein In_{(1-y)}Al_{y}As→In_{(1-y)}Al_{y}O). As “y” increases, the oxidation rate of In_{(1-y)}Al_{y}As also increases. Undesirably, however, increases in “y” are also accompanied by excessive amounts of strain and dislocations within adjacent layers. AlAsSb, another aluminum containing Group III-V semiconductor material lattice-matched to InP, oxidizes quickly at low temperatures but deleteriously decomposes into metallic Sb as it oxidizes and forms interfacial layers that lead to increased strain in the oxidized structure, thus reducing the reliability of the VCSEL device.

To overcome the aforementioned limitations of ternary AlInAs and AlAsSb materials that are compatible with InP-based material systems, AlGaAsSb-based materials with a high refractive index contrasts similar to AlGaAs-based systems and relatively fast oxidation rates have been closely examined. However, the accuracy and reproducibility of an As/Sb composition in an AlGaAsSb system is very difficult to achieve during conventional layer fabrication. Moreover, while AlPSb-based materials may oxide quickly, they too are difficult to grow.

Thus, new long wavelength VCSELs would be beneficial. Even more benefical would be a new method to fabricate fast oxidizing current confinement layers that are compatible with the InP material system.

### SUMMARY OF THE INVENTION

Accordingly, the present invention is directed to digital alloy oxidation layers that substantially obviates one or more of the problems due to limitations and disadvantages of the related art.

An advantage of the present invention provides a digital alloy used in forming current confinement structures that is lattice-matched to InP material systems.

Another advantage of the present invention provides a digital alloy used in forming current confinement structures that has a relatively fast oxidation rate.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a VCSEL may, for example, include an active region; a DBR arranged over the active region; and a current confinement layer between the active region and the DBR, wherein the current confinement layer includes a digital alloy comprised of a stack of alternating first digital alloy sub-layers and second digital alloy sub-layers.

In another aspect of the present invention, a method of fabricating a VCSEL may, for example, include providing an active region; forming a current confinement layer over the active region; and forming a DBR over the active region; and oxidizing a portion the current confinement layer to form a central aperture, wherein a current confinement layer between the active region and the DBR, wherein forming the current confinement layer includes forming a digital alloy comprised of a stack of alternating first digital alloy sub-layers and second digital alloy sub-layers.

It is to be understood that both the foregoing general description and the following detailed description are exemplary and explanatory and are intended to provide further explanation of the invention as claimed.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 illustrates a typical VCSEL;

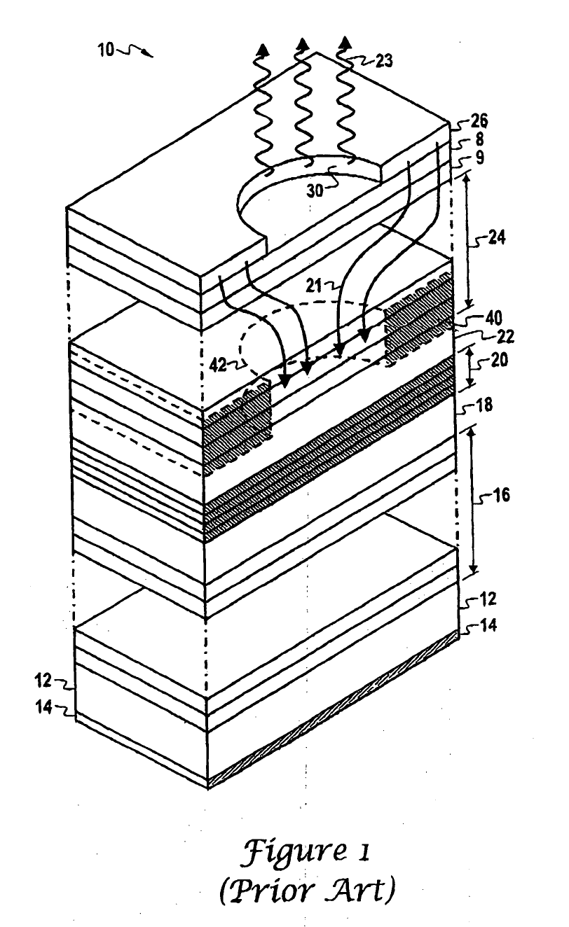

FIG. 2 illustrates an exemplary VCSEL including a digital alloy layer stack of a current confinement layer according to principles of the present invention; and

FIG. 3 illustrates an exemplary digital alloy layer stack in according to the principles of the present invention.

### DETAILED DESCRIPTION OF THE PREFERRED EMBODIMENTS

Reference will now be made in detail to embodiments of the present invention, examples of which are illustrated in the accompanying drawings.

As mentioned above, while complex ternary and even quaternary compounds may be desirable or even necessary as oxidation layers within InP systems, they can be difficult to grow. The principles of the present invention exploit the relative ease with which particular binary compounds can be grown, the combination of which can produce layers suitable for oxide aperture formation.

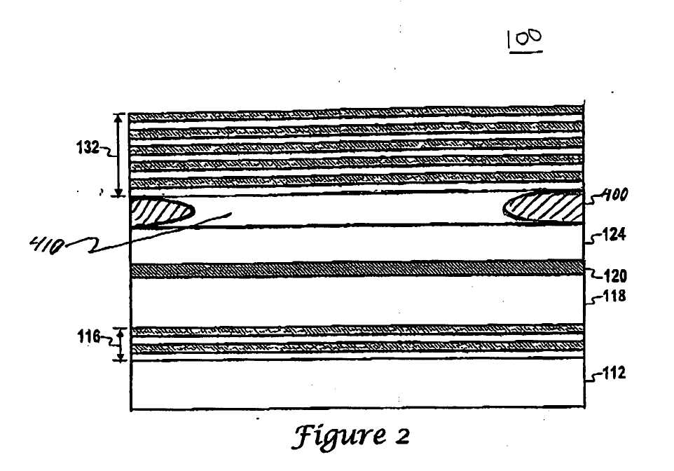

FIG. 2 illustrates an exemplary vertical cavity surface emitting laser (VCSEL) including a digital alloy layer stack of a current confinement layer according to principles of the present invention.

As shown in FIG. 2, an exemplary long-wavelength VCSEL 100 may, for example, include an n-doped InP substrate 112 having an n-type electrical contact (not shown for clarity). Over the InP substrate 112 may include an n-doped lower mirror stack 116 (including a DBR) comprised of a plurality of alternating layers of, for example, AlGaInAs/AlInAs. Although one of skill in the art can appreciate other compounds for the alternating layers in the lower mirror stack 116. Over the lower mirror stack 116 is an n-doped InP spacer 118. The lower mirror stack 116 may be beneficially grown on the InP substrate using common metal-organic and hydride precursors such as TMAI, TMGa, PH₃, and AsH₃ in a metal-organic chemical vapor deposition (MOCVD) process. Next, an InP spacer 118 may be grown, also using MOCVD processes. An active region 120 comprised of P-N junction structures and having a number of quantum wells is then formed over the InP spacer 118. The composition of the active region 120 is beneficially InGaAsP or AlInGaAs in one embodiment.

An n-type InP top spacer 124 may be formed over the active region 120. Subsequently, the current confinement layer 400 may, for example, be formed over the InP top spacer 124, and partially oxidized, as will be discussed in greater detail below. Next, an n-type top mirror stack (which may include another DBR) 132 may be disposed over the current confinement layer 400. In one aspect of the present invention, the top mirror stack 132 may, for example, include alternating layers of materials having high and low indicies of refraction (e.g., AlGaAs, InGaP, InGaAsP, etc.). In one aspect of the present invention, depending upon the materials used to form the current confinement layer 400 and top mirror stack 132, the current confinement layer 400 may be considered as a part of the top mirror stack 132.

After forming the top mirror stack 132, the current confinement layer 400 may be oxidized by any suitable means to form an isolating ring around a central aperture 410. The size of the central aperture 410 may be controlled by adjusting the time during which the current confinement layer 400 (or portion of the top mirror stack 132 including the current confinement layer 400) is oxidized by any known technique. Accordingly, the central aperture 410 may serve as the electrical current pathway, enabling the VCSEL 100 to be electrically pumped. Besides providing the electrical current pathway, the current confinement layer 400 may also provide strong index guiding to the optical mode of the VCSEL 100.

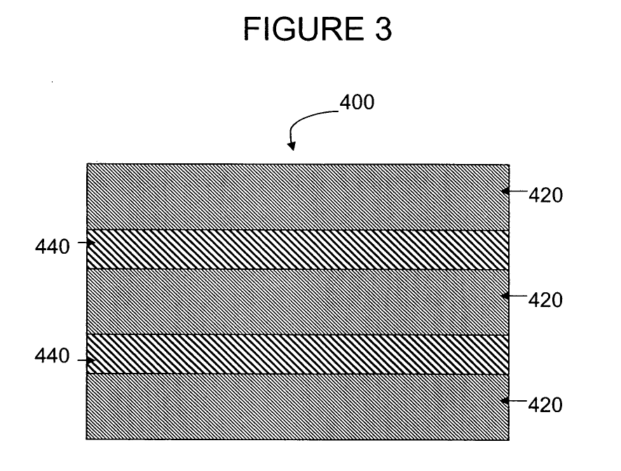

FIG. 3 illustrates an exemplary digital alloy layer stack in according to the principles of the present invention.

Referring to FIG. 3, the current confinement structure 400 may beneficially comprise a digital alloy. Generally, a digital alloy may refer to a material having a uniform average composition formed by stacking of individual layers, which are usually described in terms of atomic monolayer compositions. For example, In_{0.75}Ga_{0.25}As could be formed as a homogenous alloy having the indicated compositions or it could be formed as a digital alloy, wherein one period of the digital alloy consists of three monolayers of InAs and one monolayer of GaAs (or, alternatively, two monolayers of InAs and two monolayers of In_{0.5}Ga_{0.5}As).

According to principles of the present invention, the inventive digital alloy comprises an alternating stack of first digital alloy sub-layers 420 and second digital alloy sub-layers 440. Generally, the thickness of each first digital alloy sub-layer 420 may be equal to, or greater than, the thickness of each second digital alloy sub-layer 440. Moreover, each first digital alloy sub-layer 420 may be formed of a different material than each second digital alloy sub-layer 440. In one example, the material from which the second digital alloy sub-layer 440 is formed may oxidize at a faster rate than the material from which the first digital alloy sub-layer 420 is formed.

Due to the physical and material characteristics of the first and second digital alloy sub-layers, the digital alloy of the present invention oxidizes at a faster rate than the individual components it is formed of. For example, the second digital alloy sub-layer 440 is formed of a relatively fast oxidizing material. Due to its relatively small thickness, however, oxygen cannot be easily incorporated within the bulk of the second digital alloy sub-layer 440. The first digital alloy sub-layer 420 is formed of a relatively slow oxidizing material. Due to its thickness, however, oxygen can be incorporated within the bulk of the first digital alloy sub-layer 420 more easily than within the second digital alloy sub-layer 440. Accordingly, when stacked upon each other as shown in FIG. 3, the first digital alloy sub-layer 420 may be oxidized from oxygen provided by the second digital alloy sub-layer 440 and vice versa. As a result, the current confinement structure 400 may be oxidized at a relatively fast rate, may be lattice-matched to a specific material system, and be grown using known and reliable methods.

According to principles of the present invention, each first digital alloy sub-layer 420 may be about 5-10 nm thick while each second digital alloy sub-layer may be about 5 nm thick.

In one aspect of the present invention, the first digital alloy sub-layers 420 may be formed of the same or different materials. Accordingly, each of the first digital alloy sub-layers 420 may, for example, include AlInAs, AlGaAs, AlGaP, AlInP, AlGaSb, AlInSb, AlAsSb, AlPSb, and the like. It is appreciated that the first digital alloy sub-layers 420 may be formed using substantially any known deposition techniques.

In one aspect of the present invention, each of the second digital alloy sub-layers 440 may include the same or different materials. In another aspect of the present invention, each of the second digital alloy sub-layers 440 may include binary or ternary compounds including components of any of the ternary compounds of which adjacent ones of the first digital alloy sub-layers 420 are comprised. Accordingly, each of the second digital alloy sub-layers 440 may, for example, include AlSb, AlAs, AlP, AlInAs, AlGaAs, AlGaP, AlInP, AlGaSb, AlInSb, AlAsSb, AIPSb, and the like. It is appreciated that the second digital alloy sub-layers 420 may be formed using substantially any known deposition techniques.

According to principles of the present invention, the digital alloy stack shown in FIG. 3 may be repeated as desired. It should, however, be appreciated that a digital alloy with fewer interfaces is easier to implement within an actual VCSEL design. Moreover, the digital alloy structure should be strain compensated before the digital alloy structure reaches a critical thickness. A strained layer, which may be beneficial because of its oxidation properties, cannot be epitaxially grown beyond a critical thickness without generating undesirable defects in the grown crystal. This can be prevented by epitaxially growing a layer of the opposite strain, thereby compensating or reducing the overall strain of the combination material. Lastly, if one sub-layer is difficult to grow on another, e.g., due to different growth conditions, etc., a suitable transition material having a graded composition may be interposed between the two sub-layers.

According to principles of the present invention, a current confinement structure including a digital alloy can be used to create oxide apertures of VCSELs to, for example, confine electrical current to a desired area, thereby reducing the operating current of the device. Moreover, the current confinement structure 400 of the present invention may be oxidized at a relatively fast rate, may be lattice-matched to specific material systems, and be grown using known and reliable methods.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A vertical cavity surface emitting laser (VCSEL), comprising:
an active region;
a current confinement layer arranged over the active region, wherein the current confinement layer includes a digital alloy comprised of a stack of alternating first digital alloy sub-layers and second digital alloy sub-layers; and
a distributed Bragg reflector (DBR) arranged over the active region.

2. The VCSEL according to claim 1, wherein the first digital alloy sub-layers are the same thickness as the second digital alloy sub-layers.

3. The VCSEL according to claim 1, wherein the first digital alloy sub-layers are thicker that the second digital alloy sub-layers.

4. The VCSEL according to claim 1, wherein each first digital alloy sub-layer is about 10 nm thick.

5. The VCSEL according to claim 1, wherein each second digital alloy sub-layer is about 5 nm thick.

6. The VCSEL according to claim 1, wherein each first digital alloy sub-layer is formed of a different material than each second digital alloy sub-layer.

7. The VCSEL according to claim 6, wherein each first digital alloy sub-layer comprises a ternary compound.

8. The VCSEL according to claim 7, wherein each first digital alloy sub-layer comprises a material selected from the group consisting AlInAs, AlGaAs, AlGaP, AlInP, AlGaSb, AlInSb, AlAsSb, and AlPSb.

9. The VCSEL according to claim 6, wherein each second digital alloy sub-layer comprises a binary or ternary compound.

10. The VCSEL according to claim 9, wherein each second digital alloy sub-layer comprises a binary or ternary compound including components of the material forming an adjacent first digital alloy sub-layer.

11. The VCSEL according to claim 10, wherein each second digital alloy sub-layer comprises a material selected from the group consisting AlSb, AlAs, AlP, AlInAs, AlGaAs, AlGaP, AlInP, AlGaSb, AlInSb, AlAsSb, and AlPSb.

12. A method of fabricating a vertical cavity surface emitting laser (VCSEL), comprising:
forming a current confinement layer over an active region;
forming a distributed Bragg reflector (DBR) over the active region; and
oxidizing a portion the current confinement layer to form a central aperture,
wherein forming the current confinement layer includes forming a digital alloy comprised of a stack of alternating first digital alloy sub-layers and second digital alloy sub-layers.

13. The VCSEL according to claim 12, wherein the first digital alloy sub-layers are the same thickness as the second digital alloy sub-layers.

14. The VCSEL according to claim 12, wherein the first digital alloy sub-layers are thicker that the second digital alloy sub-layers.

15. The VCSEL according to claim 12, wherein each first digital alloy sub-layer is about 10 nm thick.

16. The VCSEL according to claim 12, wherein each second digital alloy sub-layer is about 5 nm thick.

17. The VCSEL according to claim 12, wherein each first digital alloy sub-layer is formed of a different material than each second digital alloy sub-layer.

18. The VCSEL according to claim 17, wherein each first digital alloy sub-layer comprises a ternary compound.

19. The VCSEL according to claim 18, wherein each first digital alloy sub-layer comprises a material selected from the group consisting AlInAs, AlGaAs, AlGaP, AlInP, AlGaSb, AlInSb, AlAsSb, and AlPSb.

20. The VCSEL according to claim 17, wherein each second digital alloy sub-layer comprises a binary or ternary compound.

21. The VCSEL according to claim 20, wherein each second digital alloy sub-layer comprises a binary or ternary compound including components of the material forming an adjacent first digital alloy sub-layer.

22. The VCSEL according to claim 21, wherein each second digital alloy sub-layer comprises a material selected from the group consisting AlSb, AlAs, AlP, AlInAs, AlGaAs, AlGaP, AlInP, AlGaSb, AlInSb, AlAsSb, and AlPSb.
